(19) United States
(12) Patent Application Publication
(10) Pub. No.: US 2011/0158762 A1
(43) Pub. Date: Jun. 30, 2011

(54) Strap tension device

(76) Inventor: Izell L. Promise, Matteson, IL (US)

(21) Appl. No.: 12/928,379

(22) Filed: Dec. 10, 2010

Related U.S. Application Data
(60) Provisional application No. 61/283,893, filed on Dec. 10, 2009.

(51) Int. Cl. B60P 7/08; B60P 7/06

(52) U.S. Cl. 410/103; 24/68 CD

(57) ABSTRACT

The Strap Tension Device consists of a rectangular frame produced in a variety of dimensions depending on the truck to be equipped, and in materials ranging from injection-molded thermoplastic resins in one embodiment to aluminum and steel in other embodiments. The Strap Tension Device is produced in a pallet-type embodiment for flatbed trucks, as a perimeter frame or rail for flatbed trucks in another embodiment, and even as a top-rail fitting for the beds of pickups in yet another embodiment. In one embodiment, the device of the present invention features a series of inset, spring-loaded, sliding tensioning blocks and in another embodiment, clamps. When depressed, these clamps create an opening at the outer side of the frame, an opening through which the user pulls a two inch nylon cargo strap. When the straps have been passed through the tensioning clamps and pulled tight to secure the load, the clamps are released, locking the straps in position and thus securing the load. The Strap Tension Device contains a mechanism by which the spring-clamps, which are tensioned by a pair of compression springs, slide in their housings.

### CLAIM OF PRIORITY

This patent application claims priority under 35 USC 119 (e) (1) from U.S. Provisional Patent Application Ser. No. 61/283,893 filed Dec. 20, 2009, of common inventorship herewith entitled, “Strap Tension Device.”

### FIELD OF THE INVENTION

The present invention pertains to the field of truck cargo securing devices, and more specifically to the field of cargo transportation devices with adjustable tension mechanisms.

### BACKGROUND OF THE INVENTION

The prior art has put forth several designs for truck cargo securing devices. Among these are:

U.S. Pat. No. 5,161,789 to Winston L. Rogers describes a universal clamping device for use in woodworking or other fabricating projects including a plurality of corner pieces including means to accept clamping straps, guiding dowels and accessories permitting the easy clamping of a variety of shapes and creating clamping pressure in a wide variety of directions and in multiple directions simultaneously.

U.S. Pat. No. 6,821,068 to Hugh David Facey et al. describes a load strapping means for use with four way pallet which comprises a cap for placing on a load on a four way pallet at least two strapping strands retractable through openings into housings at opposite sides of the cap, spring means within the housings for retracting the strapping strands, hooks on the free ends of the strapping strands for engagement with the underside of the platform of a four way pallet, tensioning means within the housings for tightening the strapping strands between the cap and the pallet, and stop means for limiting retraction of the hooks into the housing when not engaged with a pallet.

U.S. Pat. No. 6,926,258 to Paul Sowa et al. describes a strap tension retaining device is configured for a use with a bulk unit secured by a strap under tension. Such a bulk unit load has a corner and defines a bulk unit perimeter. The strap tension retaining device includes a fixed base element, fixed relative to the bulk unit load, a floating element movable relative to the fixed base element, a biasing element mounted between the floating element and the fixed base element and a guide element mounting the floating element to the fixed base element to guide movement of the floating element relative to the fixed base element.

None of these prior art references describe the present invention.

### SUMMARY OF THE INVENTION

It is an object of the present invention to provide a cargo transportation device with adjustable tension mechanisms.

### BRIEF DESCRIPTION OF THE DRAWINGS

FIG. 1 is an elevational view of a portion of the apparatus.

FIG. 2 is an elevational angled perspective view of the device of the present invention.

FIG. 3 shows a close-up elevational view of a portion of the apparatus.

FIG. 4 is a front schematic view of the strap tension device of the present invention.

FIG. 4 is a side schematic view of the strap tension device of the present invention.

FIG. 4 is a perspective schematic view of the strap tension device of the present invention.

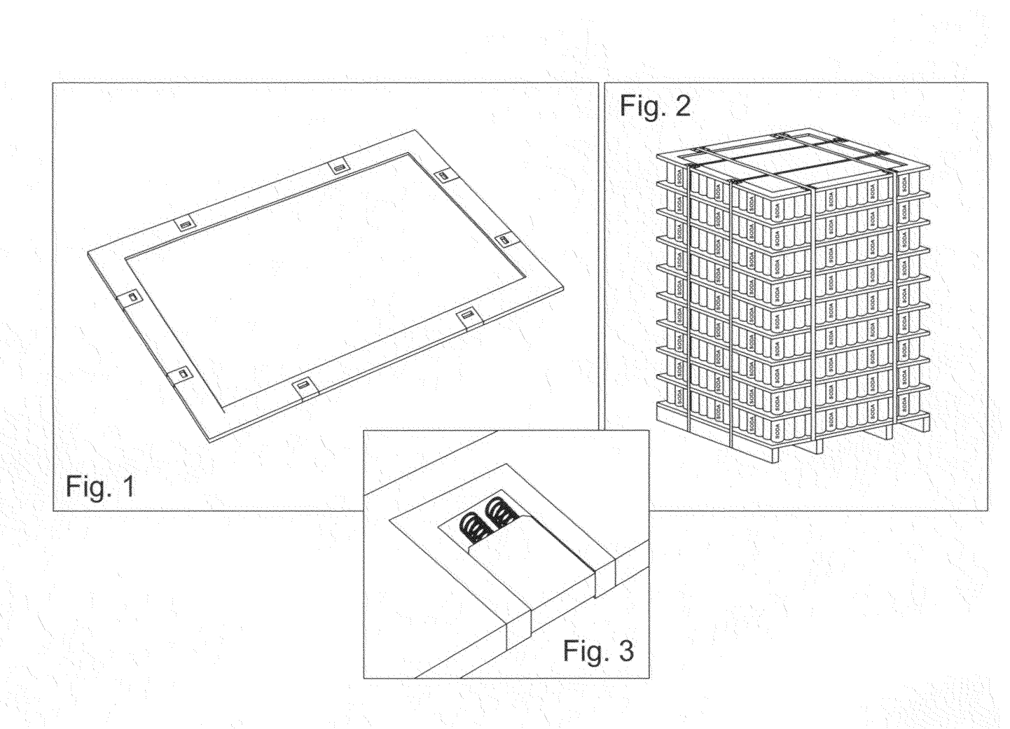

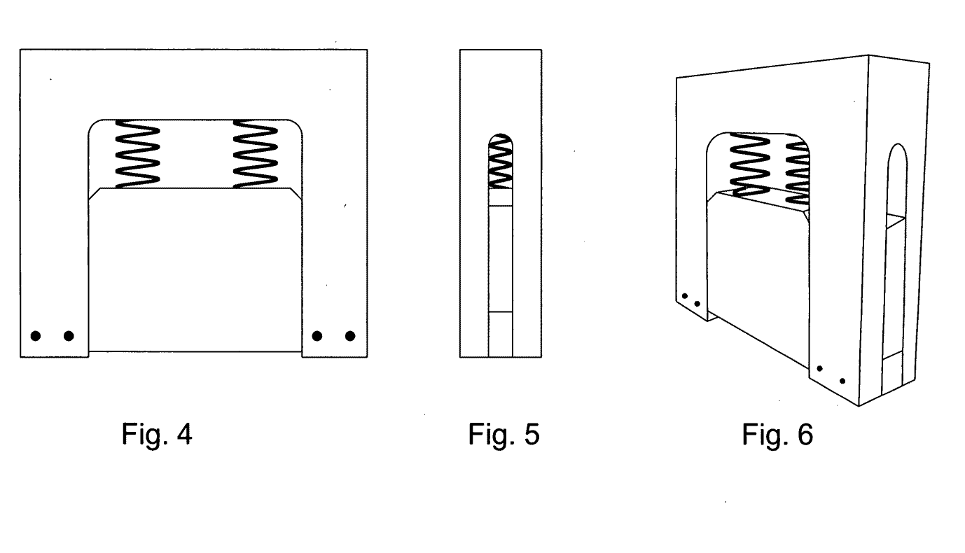

### DETAILED DESCRIPTION OF THE INVENTION

Almost all of us today rely upon a vast network of strangers to bring us the essentials of life, from the water that runs from our taps to the electricity that powers our refrigerators, to the milk on the top shelf in our refrigerator. But few of us know much about, or ever stop to consider, the complicated networks of production, transportation, and distribution which stretch invisibly between ourselves as consumers and the people responsible for the products, goods, and services upon which we depend. It seldom occurs to us, for example, that the milk on the top shelf in our refrigerator may be the final output of a complex system which begins with a dairy farm hundreds of miles away, which then moves on to a pasteurizing and packaging plant in another location, then to a refrigerated distribution and delivery center in yet another location and finally to the store where we purchase it before it reaches its final resting place at our home, in our refrigerator.

Because they are really separate worlds unto themselves, the great and overarching systems which supply us with clean water, abundant electricity, and an endless flow of goods and services are likely to remain a mystery to us. We all have our own work to do, probably its intricacies are a mystery to everybody else, and we don't really care about the details of how we get our morning paper, as long as we get it. Likewise, we are inevitably ignorant of the details, annoyances, and frustrations inherent in another person's occupation. As a case in point, the present invention, hereinafter referred to as Strap Tension Device deals with an annoyance unsuspected by almost all of us, but known too well to the men and women who deliver the nation's goods, whether locally or long-distance, by truck. Truck transport, whether by flatbed across country or by pickup across town, involves the necessity of tying down the load to secure it against loss and breakage. The present invention described herein provides drivers with a safe, simple, and effective system for tying down loads with tensioned straps.

The present invention, hereinafter referred as the Strap Tension Device consists of a rectangular frame produced in a variety of dimensions depending on the truck to be equipped, and in materials ranging from injection-molded thermoplastic resins in one embodiment to aluminum and steel in other embodiments. Manufactured by the Hardware industry, the Strap Tension Device is produced in a pallet-type embodiment for flatbed trucks, as a perimeter frame or rail for flatbed trucks in another embodiment, and even as a top-rail fitting for the beds of pickups in yet another embodiment. In one embodiment, the device of the present invention features a series of inset, spring-loaded, sliding tensioning blocks and in another embodiment, clamps. When depressed, these clamps create an opening at the outer side of the frame, an opening through which the user pulls a two inch nylon cargo strap. When the straps have been passed through the tensioning clamps and pulled tight to secure the load, the clamps are released, locking the straps in position and thus securing the load.

The Strap Tension Device contains a mechanism by which the spring-clamps, which are tensioned by a pair of compression springs, slide in their housings.

The Strap Tension Device, an innovative system for securing loads for truck transport, presents a number of distinct and significant benefits and advantages. Foremost, the Strap Tension Device is versatile, and produced for use with trucks ranging from cross-country flatbeds to household pickups. The Strap Tension Device enables the professional trucker or do-it-yourself householder to quickly and easily secure a wide variety of loads and cargo with standard, two inch cargo straps, as the Strap Tension Device features from eight to twelve regularly spaced spring-clamps designed to hold the cargo straps secure and under adequate tension. Since the spring-clamps are spaced at intervals around the periphery of the Tension Device's frame, the user has ample sites for the use of his or her cargo straps. Easy to use and versatile enough for both professional truckers and around-town pickup drivers, the Strap Tension Device is built of tough and durable, high-quality components, and requires no particular maintenance for a long working life.

A system for strapping down and securing loads transported by truck, the Strap Tension Device enables anyone, whether a professional flatbed driver or a household consumer pickup driver, to quickly and easily secure a wide variety of loads for safe transport. Cleverly conceived and thoughtfully designed to meet the needs of all truck drivers, the Strap Tension Device finds a wide and receptive market among the nation's pickup owners and professional truckers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A cargo transportation device with adjustable tension mechanisms, comprising a rectangular frame further comprising a tensioning device; wherein the tensioning device contains a mechanism by which spring-clamps slide in their housings and are tensioned by a pair of compression springs.

2. The device of claim 1 comprising materials selected from the group. consisting of: injection-molded thermoplastic resins, aluminum and steel.

3. The device of claim 1 wherein the device is in a pallet-type configuration for flatbed trucks.

4. The device of claim 1 wherein the device is configured as a perimeter frame or rail for flatbed trucks.

5. The device of claim 1, wherein the device is configured as a top-rail fitting for the beds of pickup trucks.

6. The device of claim 1 wherein the tensioning device comprises a series of inset, spring-loaded, sliding tensioning blocks.

7. The device of claim 1 wherein the tensioning device comprises clamps, and wherein the clamps create an opening at the outer side of the frame when depressed, and the user pulls a two inch nylon cargo strap through the opening, and when the straps have been passed through the tensioning clamps and pulled tight to secure the load, the clamps are released, locking the straps in position and thus secure the load.
